(19) United States
(12) Patent Application Publication
(10) Pub. No.: US 2022/0383317 A1
(43) Pub. Date: Dec. 1, 2022

(54) VIRTUAL GIFT CARDS WITH INSTANT DELIVERY AND SECURED REMOTE REDEMPTION

(71) Applicant: Aldelo, LP, Pleasanton, CA (US)

(72) Inventor: Harry TU, Pleasanton, CA (US)

(73) Assignee: Aldelo, LP, Pleasanton, CA (US)

(21) Appl. No.: 17/818,599

(22) Filed: Aug. 9, 2022

Related U.S. Application Data
(63) Continuation of application No. PCT/US2021/031092, filed on May 6, 2021.
(60) Provisional application No. 63/022,156, filed on May 8, 2020.

(51) Int. Cl. G06Q 20/40; G06Q 20/04; G06Q 20/34

(52) U.S. Cl. CPC G06Q 20/409; G06Q 20/0457; G06Q 20/351; G06Q 20/342; G06Q 20/354

(57) ABSTRACT

The present disclosure involves systems, software, and computer implemented methods for an improved method and system for providing payment card management and secured remote redemption without disclosure of a full card number. In one example method, a cloud service receives a notification from a merchant associated with a new payment card activation, the notification including a messaging identifier corresponding to an account associated with the payment card and its value. The cloud service can then associate, in an account associated with the messaging identifier, the new payment card and the messaging identifier. The new payment card is then assigned the value of the new payment card, and the cloud service can generate a notification message specific to the account associated with the messaging identifier, and can transmit the notification to a device associated with the messaging identifier of the account.

### CROSS-REFERENCE TO RELATED APPLICATIONS

This application is a continuation of, and claims priority to International Application No. PCT/US2021/031092 filed on May 6, 2021, which claims priority to U.S. Provisional Application Ser. No. 63/022,156 filed on May 8, 2020, the entire contents of each and both are incorporated herein by reference in its entirety.

### TECHNICAL FIELD

This specification generally relates to an improved method and system for providing virtual gift cards and secured remote redemption without disclosure of a full card number.

### BACKGROUND

In the case of physical gift cards, a buyer may acquire the physical gift cards from a seller, who may be different than the merchant associated with the gift card. Gifts cards can generally be sold by the card-issuing merchant, by another merchant within the same franchise or group of stores, or by a third-party seller, such as a marketplace, supermarket, or online retailer. The physical gift card can be used for payment transactions and/or to reload value onto the card. Many examples can be found in grocery stores and retailers, where a wide array of gift cards may be available and may be offered for sale. Once a card is selected, the card is taken to the register, paid for, and is activated for use. Once activated, the cards are ready for use by the buyer, or a person to whom the buyer has provided the card. The cards may, in general, be used via magnetic stripe swiping at a point-of-sale, or via account number input into the point-of-sale by the buyer or by the seller's agent or employee. The value of the physical cards may also be redeemed online by entering the card's unique number in a web page or app associated with the merchant.

For cards delivered electronically, a buyer usually acquires the electronic version of the gift card from merchant, or a third-party seller, and can use it on payment transactions or to perform further loading or reloading of the gift card. One example is an Amazon.com gift card bought on Amazon.com and selected for e-delivery, such as via email or text, to a recipient, who may be the buyer or another person designated by the buyer. Similar examples include Starbucks gift cards purchased, for instance, in the Starbucks app. Further funds can be added to the card, or purchases can be made through the app by redeeming existing gift card values at a point-of-sale when the user is logged in.

### SUMMARY

The present disclosure involves systems, software, and computer implemented methods for an improved method and system for providing payment card management and secured remote redemption without disclosure of a full card number.

In one example method, a cloud service receives a notification from a merchant associated with a new payment card activation, where the notification includes a unique messaging identifier corresponding to a consumer account associated with the new payment card and a value of the new payment card. The cloud service can then associate, in a consumer account associated with the unique messaging identifier, the new payment card and the unique messaging identifier. The cloud service can then assign the new payment card a value associated with the value of the new payment card. The cloud service can then generate a notification message specific to the consumer account associated with the unique messaging identifier and the new payment card, and can transmit the generated notification to the unique messaging identifier of the consumer account.

In one example implementation, the unique messaging identifier can comprise a phone number of the consumer or a short messaging service (SMS) number associated with the consumer.

In some implementations, the new payment card comprises a gift card. In some of those instances, the gift card is a gift card for the merchant associated with the new payment card activation. In other instances, the gift card is not a gift card specifically associated with the merchant, but is instead a generic gift card associated with the new payment card activation.

In some implementations, the notification message includes a uniform resource locator (URL) providing a link to a consumer-specific account wallet associated with the cloud service.

In some instances, the merchant is a first merchant and the unique messaging identifier is a first unique messaging identifier, where the method further comprises, among others, receiving, from a second merchant, a second unique messaging identifier associated with an attempt to redeem value from a consumer account, the second unique messaging identifier provided by the second merchant. The cloud service can validate the received second unique messaging identifier to determine an associated consumer account. The cloud service can then generate a list of one or more payment cards associated with the determined consumer account, where the list of one or more payment cards is masked such that only a portion of an identifier or account number of each payment card is visible. The cloud service can then transmit the generated list of one or more payment cards to the merchant. The cloud service can then receive, from the second merchant, an identification of a particular payment card from the generated list to be used for the attempted redemption. Based on the received identification, the cloud service can then process the attempted redemption from the consumer account using the particular identified payment card.

In some instances, and after receiving the identification of the particular payment card and prior to processing the attempted redemption, the cloud service can generate a third unique identifier representing a redeem code, and transmit that the third unique identifier to a device associated with the second unique messaging identifier, wherein the third unique identifier is used to verify the consumer associated with the second unique messaging identifier. A fourth unique identifier is then received from the second merchant, where the fourth unique identifier is received by the second merchant from a user attempting the redemption. The cloud service can compare the received fourth unique identifier to the generated third unique identifier, and in response to determining that the received fourth unique identifier is the same as the generated third unique identifier, the cloud service can authorize the processing of the attempted redemption.

In some of those instances, the generated third unique identifier is associated with a validity period. If the generated third unique identifier is not received from the second merchant within that validity period, then the processing of the attempted redemption is not authorized, even when the third and fourth unique identifiers match or are otherwise identical.

In an alternative method, a cloud service receives a request to redeem value from at least one payment card associated with a consumer account. The cloud service can store account data for a plurality of payment cards for the consumer account, and may store information regarding a plurality of consumer accounts. In response to receiving the request, the cloud service can generate a first unique identifier associated with the consumer account, where the first unique identifier corresponds to a request to use an aggregated payment solution from the plurality of payment cards associated with the consumer account. The cloud service then transmits, to a device associated with the consumer account, the generated first unique identifier.

The cloud service can then receive, from a merchant, a second unique identifier and a set of transaction-related information for processing a transaction associated with the merchant and a consumer. In response to confirming that the second unique identifier corresponds to the first unique identifier, the cloud service can identify at least one payment card from the plurality of payment cards for the consumer account associated with the first unique identifier that are available for use at the merchant, and the identified at least one payment card can be used to process the transaction for the merchant. In response to processing the transaction, the cloud service can notify the merchant of the completed transaction.

In some implementations, the set of transaction-related information includes an amount of the transaction. Further, identifying the at least one payment card from the plurality of payment cards for the consumer account associated with the first unique identifier available for use at the merchant can comprises identifying the plurality of payment cards for the consumer account, determining a subset of the plurality of payments cards which can be used at the merchant, and determining, from the subset of the plurality of payment cards, a priority order of payment application from the subset of the plurality of payment cards.

In those instances, using the identified at least one payment card to process the transaction for the merchant can include applying a first payment card from the subset of the plurality of payment cards having a relatively highest priority to the amount of the transaction, and, in response to determining that an amount available associated with the first payment card is not equal to or higher than the amount of the transaction, applying at least a second payment card from the subset of the plurality of payment cards having a relatively second highest priority to the amount of the transaction.

In some of those implementations, determining, from the subset of the plurality of payment cards, the priority order of payment application from the subset of the plurality of payment cards can include assigning payment cards from the subset of the plurality of the payment cards specifically associated with the merchant a relatively highest priority, and assigning payment cards from the subset of the plurality of payment cards not specifically associated with the merchant a relatively lower priority.

In some of those implementations, the first payment card comprises a gift card issued directly by and associated with the merchant, and the at least the second payment card comprises a generic gift card not specifically associated with the merchant.

In other implementations, the first payment card comprises a gift card issued directly by and associated with the merchant, and the at least the second payment card comprises a credit or debit card.

In some implementations, the request to redeem value comprises an explicit request to use the aggregated payment solution. Additional, the request to redeem value may be received from the device associated with the consumer account.

In some instances, the first unique identifier is associated with a validity period, where, if the first unique identifier is determined to be outside of the validity period when the second unique identifier is confirmed as corresponding to the first unique identifier, then the aggregated payment process ends and no payment processing is performed.

While generally described as computer-implemented methods, some or all of the aspects may be computer-implemented software embodied on tangible media that processes and transforms the respective data, or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example system for payment card management, registration, and redemption.

FIG. 2 illustrates an example set of flows between a buyer or consumer, a seller or merchant, and a cloud service according to one implementation.

FIG. 3 illustrates an example process for reloading an existing gift card managed in the cloud service according to one implementation.

FIG. 4 illustrates an example process for redeeming values of a particular payment card with a merchant according to one implementation.

FIG. 5 illustrates an example alternative process for payment card registration and management according to one implementation.

FIG. 6 is a block diagram illustrating an example alternative system for payment card management, registration, and redemption, including using an aggregate card payment process.

FIG. 7 describes an example process for performing an aggregated card transaction managed by the cloud service, according to one implementation.

FIG. 8 describes an example process for performing a biometric redemption process managed by the cloud service, according to one implementation.

### DETAILED DESCRIPTION

This specification generally relates to techniques and technological improvements to solutions for gift cards, which are traditionally delivered from seller to buyer either via physical media or electronic means, such as email, text, or app-based delivery.

Existing gift card operations, whether via online interactions or offline (e.g., physical card purchases) have existed for some time, and are generally adequate for daily use. However, further advances, including those described herein, can provide consumers a more seamless experience and with better and more dynamic security than previously and currently available.

Currently, if a buyer acquires a physical or electronic gift card, in order for the buyer to redeem, reload, or check a balance on the acquired gift card, the buyer will have to present the card in-person to the store, use it online by entering the card account number, or transact it via a telephone ordering process. Each of these actions expose the consumer and the card to fraud, including the exposure and sharing of card swipe data, barcode and/or account number risking fraud, and theft potential. Gift card balances mysteriously disappearing due to fraud, inaction, and/or fees is a common occurrence. A more secured approach with increased visibility and convenient management is needed to protect the gift cards, consumers who buy them, and merchants who offer them.

In addition, when the gift card is issued, there typically is a disconnect between the buyer and the card itself, causing the extra step of having to associate the buyer with the gift card in order to protect the parties in the event of card loss or theft. For example, if purchased gift cards are misplaced or lost using current gift card options, there are relatively few ways to easily recover such cards and their associated value unless the gift cards are already registered to a specific buyer. Further, the use of any lost cards found by others may not be able to be stopped or reversed, as the gift cards are frequently used more similarly to cash than to credit or debit cards, where some fraud protections are built in. Still further, current state and federal tax laws also require the realization of gift cards purchased but unused (e.g., inactive cards) be considered as reportable income by the merchant, such as if the unused balances pass a certain time limit requirement. Without a centralized mechanism and registration for various gift cards, merchants are unable to link existing but unused gift card funds to particular users, and are unable to notify them to use such cards. The present solution provides, in addition to its other benefits, the ability for merchants to identify and connect to consumers regarding existing cards and balances.

Although current processes provide steps to register gift cards, many of those steps require inconvenient and time-consuming interactions, including logging into particular websites and performing various required steps and interactions. Even when the process is a single extra step, many buyers fail to follow through due to the expected inconvenience, and the advanced security may not be taken advantage of.

Providing a better and seamless registration of such gift cards to the buyer can result in further and better protections for both buyers and merchants, and can allow better interactions and conversion of gift cards in the industry. While gift cards purchased or reloaded from an in-app purchase or transaction may be automatically registered, the vast majority of gift cards in the retail and restaurant industries are sold as physical or electronic gift cards without such registration, and outside an in-app purchase. More than likely, these types of gift cards are purchased in-store or via store online order systems, which deliver the gift cards but do not perform the automatic association with and registration of the customer or recipient.

Still further, an issue may be associated with redeeming physical and electronic gift cards over the phone. Requiring consumers to read or type in a typically 10- to 20-digit number to a clerk or automated system for redemption can lead to data entry errors, while also exposing the card numbers to potential future fraud. Even if the gift card has a PIN or other security code imprinted on it, the problem remains as consumers still would have to provide those security codes over the phone, thereby eliminating its protection in the future. The present solution provides additional solutions for redeeming gift cards over the phone, as well as in a public location to a local clerk, without having to read off large and bulky account numbers or exposing full card numbers, while also providing the ability of the cardholding consumer to control the authority to redeem the card.

The solution described here provides enhanced tools to offer automated registration of gift cards to their buyers without the need for special steps by the buyer, thereby providing a simple and intuitive interaction for registration. Further, the described solution enables the buyer to easily and securely redeem gift cards in any situation, and in particular, remote redemption via phone, email, or web, as well as in person. Specifically, consumers would not need to expose the full gift card account number, unique barcode, or magnetic swipe data at all. Further, consumers can maintain the control of their gift cards, including providing authorizations for particular transactions prior to their completion, giving the gift card buyer discretion. The new solution can work concurrently with existing gift cards, whether physical or electronic, so that the overall consumer experience is maximized and greater flexibility is achieved.

In an additional alternative, useful for both in-person and online payments, a solution is provided to allow for enhanced security when multiple gift cards are redeemed at one time, or where multiple gift cards may be applied to the same transaction. In this solution, consumers can securely redeem payment without disclosing their respective card number(s) to be used. Because in-store transactions require a faster speed, the use of multiple cards can be time-consuming, particularly where each card must be scanned and verified before payment is accepted.

In this solution, when a consumer is in-store to redeem a gift card associated with a particular SMS or other consumer identifier, that consumer may have multiple gift cards either associated with the particular merchant and/or redeemable there (e.g., debit-based gift cards such as American Express or other debit cards). Instead of requiring either the consumer or the merchant to determine which of a plurality of application cards to apply first (and in what order), and, in doing so, exposing each of the respective gift card numbers, this solution allows the central cloud service managing the consumer's cards in a remote wallet to generate a dynamic QR code (or other unique identifier or token) to be used in the transaction, where the QR code can be time-sensitive. The unique code can represents the whole or a part of all the gifts cards in the consumer's wallet to redeem. When the unique code is provided to the merchant, the merchant can scan or otherwise capture the code and sent it, along with transaction information, a merchant identifier, and, in some cases, a store or location identifier, to the cloud service. The cloud service can then use the received code and information to determine first which payment cards from the consumer's wallet or account may be available to apply for the current transaction. For example, when the consumer is ready to check out, the consumer can indicate a card payment option related to an aggregated payment option, such that the central service can generate the aggregated payment identifier that is associated with the consumer's account and wallet. The QR code can be scanned at the register or point-of-sale, with the captured code provided back to the central or cloud server for processing. Upon receiving the QR code or other identifier, along with the transaction information, the cloud server can internally retrieve the list of available gift and payment cards available for redemption, and can prioritize those cards based on a suitable algorithm. The prioritized cards can then be used and applied against the transaction balance, as needed, until the balance is zero, or a final payment amount is due, or that may be applied against a credit or other payment account. In doing so, the cloud server can automatically apply the funds intelligently, such as by applying merchant-specific gift cards first while applying general gift card balances later, as well as other specific or general algorithms. Details of the particular payment transactions can be provided back to the merchant, and the transaction can be completed.

In addition to a merchant point-of-sale scanning the consumer's dynamic QR code to perform the action, alternative solutions may allow the consumer, using their respective wallet app on their phone, to scan a merchant-provided QR code representing the transaction for payment, which can then cause the same aggregated transaction trigger. Using that, the consumer can create the dynamic QR for the merchant to scan and subsequently submit the result to the cloud service for processing.

In still other instances, a merchant can simply show or print the invoice along with a QR code representing a transaction to pay. Using their wallet app with the aggregated payment feature, the consumer can scan the invoice QR to trigger the similar redemptions, using the scanned merchant QR code to initiate the transactions via the cloud service.

Throughout the various solutions described herein, the payment cards and accounts able to be used in transactions are not limited to gift cards and credit cards, but can also be associated and used with reward cards, discount or promo coupons for redemption of certain reward points/discounts as payment tender, or other suitable options, such as, for example, virtual currencies stored in the wallet. Any suitable method of tender or value can be incorporated into this solution in various implementations.

In using this solution, the consumer is never forced to expose their payment card account numbers in a face-to-face transaction. Additionally, the merchant is not required to assist in selecting from a list or set of cards and subsequently redeem those requests separately, as would normally be applied for in-store transactions. Further, the nature of the interaction protects financial information security, while also greatly increasing the speed of transactions and removing manual efforts at determining the proper payment options.

In another improvement to the present solution, a facial recognition option can be provided for further security and convenience. In those instances, a consumer using the mobile application can register their facial profile with the cloud service, where the cloud service extracts facial features of the consumer to comprise an identifier of the consumer. The consumer can also associate a personal identification number (PIN) code to further protect their facial features. In doing so, and when a consumer wants to redeem one or more gift cards in their wallet, or otherwise apply an alternative payment card, merchants may provide a phone- and user device-free option to complete payment.

In this solution, the merchant may provide a facial recognition-qualified camera that can detect live facial conditions, such that a merchant can initiate a transaction via their POS, and to enter payment, can capture the consumer's facial features. The POS can then submit the captured facial features to the cloud server (e.g., encrypted using a public key of the cloud service) for processing with the transaction and its associated information, as well as the store identifier and merchant information. The cloud service can receive this information and validate the consumer's facial features to identify the consumer involved in the transaction, and, if applicable, request the corresponding PIN code. Using the gift cards and payment options stored at the cloud server allowed or available at the merchant, the cloud server can select the payment options to use and submit the transaction for payment. The biometric-based gift card solution allows consumers not to be tied to a particular mobile device for using the gift card system, while still providing the benefits of the gift card redemption described herein.

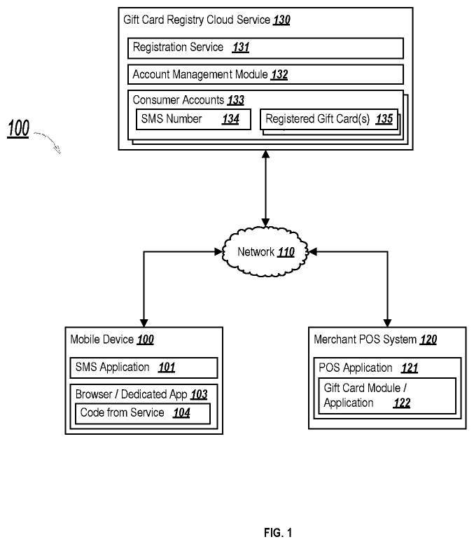

FIG. 1 illustrates an example system that can be used to manage the interactions described here. A mobile device 100 can be associated with a consumer, and can allow the consumer to perform actions related to one or more virtual gift cards associated with the consumer based on an SMS phone number stored on or associated with the mobile device 100. The mobile device 100 may be a cell phone, smart watch, tablet, or any other suitable device or computing system which is associated with a unique number for messaging. As an example for this description, the SMS number, which may be the telephone number associated with the mobile device 100, can be used. Alternatively, the unique identifier can be an email address, an instant messenger program ID (e.g., for WhatsApp), a globally unique user name or identifier specific to the cloud service 130, or any other suitable method of communication and/or messaging to the buyer. In the illustrated example, the mobile device 100 can be associated with an SMS application 101, or other suitable messaging application, which can allow the consumer to send and receive messages. Importantly, messages related to the present solution can be received and interacted with, such as by activating links associated with a cloud-based gift card service, or reviewing or presenting unique values, strings, bar codes, or other values, images, or other identifiers to merchants or sellers for verification of the consumer's active gift card account. As illustrated, the mobile device 100 can also include a browser or dedicated application 103. The browser or dedicated application 103 can be directed to or specifically associated with the gift card registry cloud service 130, and can be used to navigate to and/or interact with the virtual gift card management functions of the service 130. In some instances, such as where gift card redemption is attempted, the browser or dedicated application 103 can be used to view a unique code generated by the cloud service 130, and can be presented to a merchant to verify the consumer's identity. In some instances, the code 104 may be presented via the SMS application 101, via an email interaction, or through any other suitable method, where the code 104 represents a one-time or limited-time use value or image that can be used to validate that the consumer in possession of the mobile device 100 corresponds to the SMS number 134 of the particular consumer account 133 from which a particular gift card 135 is being applied. As noted, the browser or dedicated application 103 may a general purpose browser, such as Safari, Chrome, Firefox, or others, such as those used in mobile devices, or the application 103 may be specifically associated with and provided by the cloud service 130.

The mobile device 100, cloud service 130, and merchant system POS 120 can be connected to each other via network 110. Network 110 can be any network, including a cellular (e.g., 5G, LTE, 4G, etc.) system or network, a wired network, and/or wireless network that allows transmission of information between the illustrated (and non-illustrated) components. Network 110 can be used to transmit and/or share communications, including messages and notifications, between the mobile device 100, the merchant system 120, and the cloud service 130.

The merchant point-of-sale (POS) system 120 represents a merchant-based point-of-sale system, where financial interactions, including purchases, gift card redemptions, and gift card loading can occur. The merchant POS system 120 may be located at a particular store or location, and can represent the entirety of the merchant's POS and sales systems, or may be only a single computing device or set of computing devices local to a particular merchant location. In some instances, the merchant POS system 120 can be associated with a fully or partially web-based solution or application, with similar techniques used therein. As illustrated, the POS system 120 can include a POS application 121, which can be used to facilitate various transactions, including redemption and loading/reloading of virtual gift cards. As illustrated, a gift card module or application 122 may be included within or associated with the POS application 121, and can be used to introduce the virtual gift card services and functionality of the present solution. The gift card module or application 122 can be built or integrated into the POS application 121, or the application 122 can be a separate service, agent, or module used to interact with and allow the POS application 121 to perform the described operations. When performing a gift card-related operation associated with the cloud service 130, the module 122 can allow the POS application 121 to communicate with and perform the described functionality.

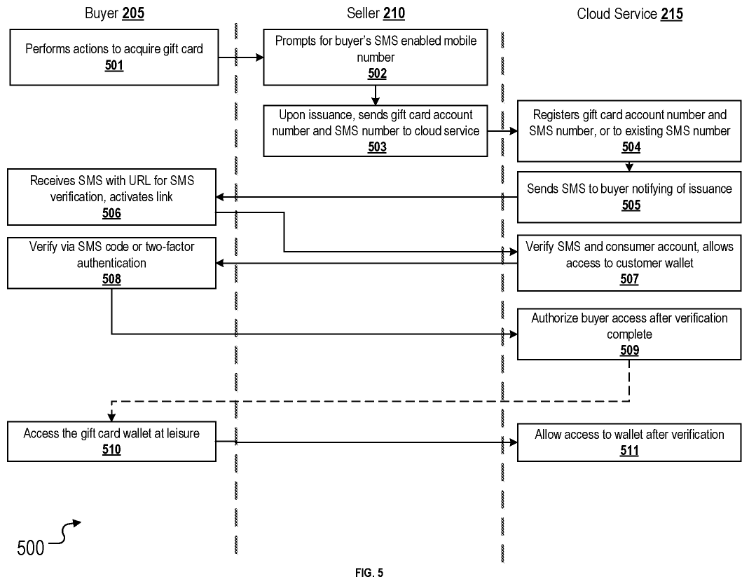

The gift card registry cloud service 130 can be a cloud-based (or server-based service) used to provide the enhanced security and functionality of the present solution. In particular, the cloud service 130 can allow for secure and simple registration of gift cards to specific SMS (or other) numbers associated with consumers, while also providing a centralized service for management of multiple cards, included where particular consumers have added multiple gift cards 135. As illustrated, a registration service 131 is used to automatically register new gift cards upon purchase, in many cases, via the merchant POS system 120 where they are purchased. An account management module 132 can allow consumers to view balances, add funds, or transfer particular cards to other consumers associated with different SMS numbers. As shown, a database or other storage mechanism can store a plurality of consumer accounts 133 for multiple consumers. Each consumer may be associated with one SMS number 134 (or other suitable identifier), which acts as a unified account identifier. That SMS number 134 can then be associated with one or more registered gift cards 135. In some instances, including those described later in FIG. 5, additional registered payment cards, including credit cards, and discount codes, among others, can be stored or associated with the consumer account 133 and used for alternative payment sources. Those will be discussed later in this disclosure.

When using the cards for redemption, the SMS number 134 can be provided via the merchant POS system 120 (e.g., by verbal provision of the consumer or by a scanned value), and can be sent to the cloud service. The cloud service 130 can identify, based on the SMS number 134, the associated gift cards 135 that are available for use at the merchant. When a particular card is selected, another, or second, unique identifier can be generated by the cloud service 130, and can be transmitted to the mobile device 100 associated with the SMS number 134. The second unique identifier can be a string of characters, a bar code, a QR code, or any other suitable value or information. The consumer can show or provide that second identifier to the merchant, who can type in, capture, scan, or otherwise enter the value in the POS application 121 and its gift card module 122. The information can be sent to the cloud service 130 and validated. In response to the validation, the redemption can be authorized and allowed, and applied to a current transaction.

Regarding the card selection when a single card or account is to be selected, a list of cards found to be associated with the consumer's unique identifier are returned as masked values, such as with the last 4 values of the card or account number visible. Those masked values can be provided to the merchant POS such that a clerk or merchant associate can see the list of options. The merchant can ask the consumer if he or she would like to use a specific card or account, or the consumer may view the list and confirm a particular choice. Once selected, the second unique identifier can be provided to the mobile device, which is used as a redeem code, and can be provided to the merchant system to authorize the transaction. The second unique identifier can be a simple numeric or alpha numeric short text, such as 4 to 8 digits in length. In other instances, the second identifier can be relatively more or less complex, and may be made of a scannable code, or any other suitable value or format. The second unique identifier may also be time sensitive, and its sole responsibility may be to be received from the cloud to the consumer or generated by the consumer in the application on demand and in response to an attempted redemption, where the second identifier is provided to the merchant at the point of payment redemption to ensure that the SMS or consumer identifier is being provided by the actual consumer. The second identifier can thus be required as input or confirmation prior to some attempted redemptions using the systems and methods provided. If the redeem code has expired, the transaction will be not be completed.

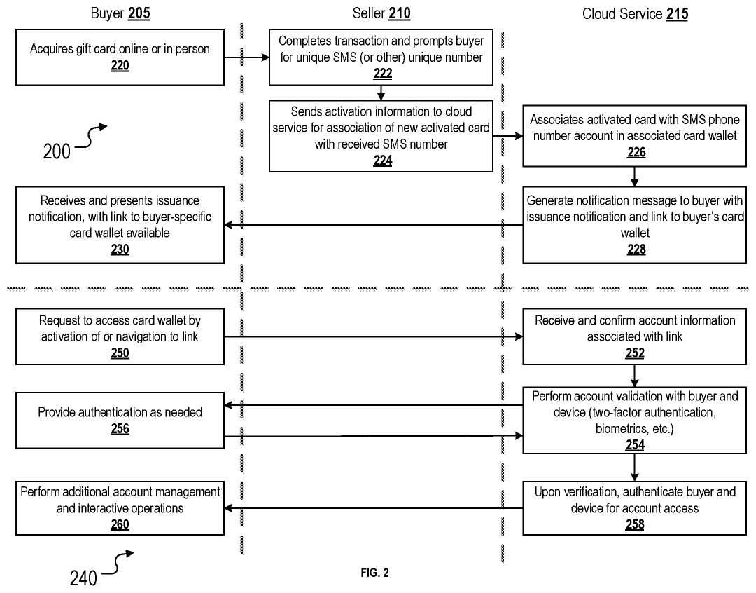

FIG. 2 illustrates an example set of flows 200 and 240 between a buyer or consumer 205 (associated with a mobile device), a seller 210 (or merchant), and a cloud service 215, here associated with the virtual gift card system. The cloud service 215 may also be associated with other payment techniques, including those described in FIGS. 5-7, although other or modified systems and services may also be used.

Flow 200 is described first. At 220, a buyer can acquire or attempt to acquire a virtual gift card online or in person at a merchant/seller. At 222, the seller 210 can complete the transaction, and can prompt the buyer 205 for a unique SMS (or other) identifier to be associated, or already associated with, the buyer's account. The seller 210 can then, at 224, send activation information to the cloud service 215, where the SMS identifier or number can be associated with the new, and now activated gift card.

At 226, the cloud service 215 can associate the activated card with the SMS identifier or number, and can associate that card to a card wallet for the buyer 205. In combination with the association, the cloud service 215 can generate a notification message to the buyer 205 at 228, which can indicate the issuance of the gift card and association with the buyer's account. In some instances, the notification can include a link or reference to a URL or other location where additional information about the consumer's account, or the new gift card, can be reviewed. At 230, the buyer 205 can receive the issuance notification and can present it via a GUI of a mobile device of the buyer 205. The presentation can provide the link to the buyer-specific card wallet and its availability. In some instances, that wallet may include information about multiple stored cards, such as where other gift cards have already been associated with the SMS account.

A second process flow 240 is also illustrated in FIG. 2. This flow describes the ability of a buyer 205 to review the newly created gift card and any additional cards associated with his SMS or other identifier. In some instances, the flow 240 may be performed directly after receiving the notification at 230, or after additional and sometimes significant time may have passed, such as for regular account review and maintenance.

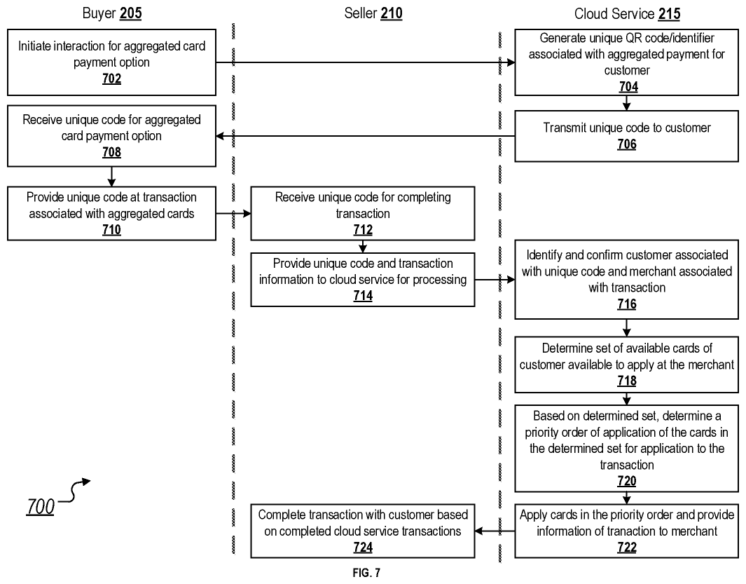

At 250, the buyer 205 can request to access his or her card wallet, such as by activating the link in the notification, or by otherwise typing in the URL to another browser or application. The request is sent to the cloud service 215, which receives and confirms the account information associated with the URL or instructions included in the link 252. The cloud service 215 can perform account verification and validation with the buyer 205 at 254, which may include a request for two-factor authentication, biometric data, or any other suitable back-and-forth. In some instances, the cloud service 215 may ask for biometric data and information to allow the consumer to the biometric payment option described in FIGS. 5 and 7.

At 256, the buyer 205 can provide the information requested or required. Upon verification, the buyer 205 associated with the link can be authenticated, as well as the device, and access to the cloud service 215 and the consumer's related account can be provided. At 260, the buyer 205 can perform account management and interactive operations within the cloud service 215 on any of the registered gift cards associated with their consumer account. No separate registration or activation is required.

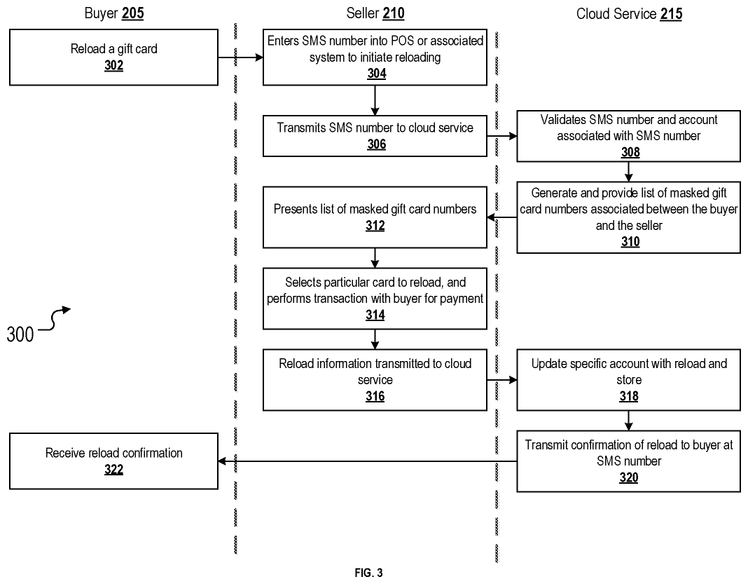

FIG. 3 describes a process 300 for reloading an existing gift card managed in the cloud service, and describes operations performed by the buyer 205, the seller 210, and the cloud service 215.

At 302, the buyer 205 can attempt to reload a registered gift card. The reloading can occur at a particular seller's location, or via an online page associated with the seller 210. In response to the reload request or action, the seller 210 can require or prompt the buyer 205 for their SMS number used for their account at 304, and that information can be entered into the POS system (e.g., a POS at a store, a e-Commerce site, etc.). At 306, the SMS number and requested reloading operation can be transmitted to the cloud service 215.

At 308, the cloud service 215 can validate the SMS number and the associated consumer account. In some instances, communication between the buyer 205 and the cloud service 215 may occur. At 310, once validated, the cloud service 215 can generate and provide a list of masked gift card numbers associated with the buyer 205 and that can be reloaded by the seller 210 back to the seller 210. In some instances, only those cards that can be used at the seller 210 can be reloaded. In other instances, cards for which the seller 210 is an authorized reloader, or that can otherwise be reloaded at the seller 210, can be provided. For example, if the seller 210 is a convenience store, they may be authorized and able to reload a number of different gift cards via one or more agreements and contracts.

At 312, the seller 210 can present the list of masked gift card numbers to the buyer 205, and through any suitable interaction, at 314, a particular card to reload is selected. This may be performed via online or verbal instructions or interactions. Also at 314, the seller 210 can accept funds to allow the transaction to occur (e.g., if reloading $50, $50 may be charged). Once the transaction is complete, or prior to completion, the reload information can be transmitted to the cloud service 215 at 316. The cloud service 215, at 318, can then update the specific consumer account associated with the reload, and can store the updated value. In some instances, a confirmation of the reload can then be transmitted to the buyer at the associated SMS number at 320, and the buyer 205 can receive and review the confirmation, accordingly.

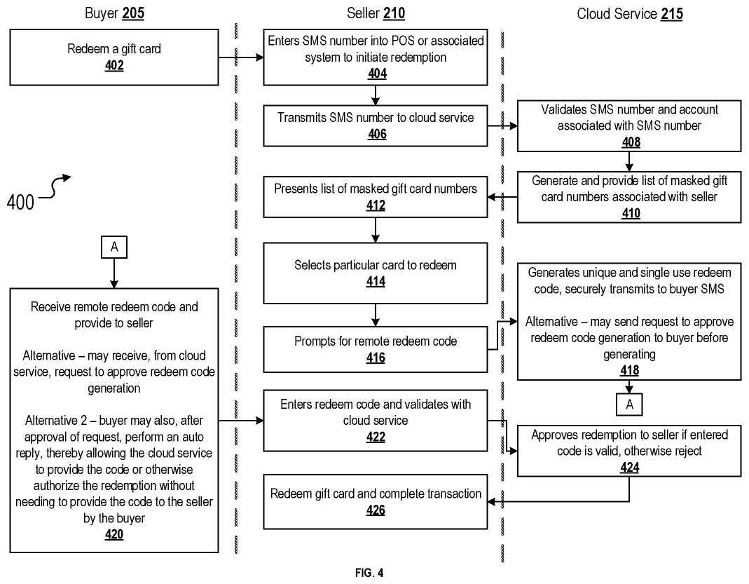

FIG. 4 illustrates an example process 400 for redeeming values of a particular gift card via a merchant. Again, interactions are described between buyer 205, seller 210, and cloud service 215. At 402, the buyer 205 can elect to redeem a gift card via a seller 210. As noted, the seller 210 may be a brick-and-mortar retailer, or the seller 210 may be online. In completing the transaction, the seller 210 (or the buyer 205, if self-service) can enter the buyer's SMS identifier or number as input into the POS system to initiate redemption during a transaction. At 406, the seller 210 can transmit the SMS number to the cloud service, which can include or otherwise indicate that a redemption is to occur.

At 408, the cloud service 215 can validate the received SMS number and the associated account. At 410, a list of masked gift card numbers of the buyer 205 that are associated with or usable at the seller can be generated and provided back to the seller 210. The seller 210 can then present that list of masked gift cards to the buyer 205 at 412. A particular card is selected for redemption at 414 (which may be selected by the buyer 205, e.g., via a user interface at the POS or via an online selection page or dropdown box, among others). During a phone- or mobile device-based transaction, seller 210 can communicate to the buyer 205 as to which card is to be used as identified by the last 4 digits of the masked card number. In those instances, the list of cards may not be sent to the buyer 205, but instead, the buyer 205 may have a list of his or her available cards for the transaction on their mobile device. In some instances, the buyer 205 can provide an electronic selection of the particular card to use (e.g., in the buyer's mobile wallet app, which can then be shared with the seller 210), the buyer 205 can manually choose or select a card through an interface of the seller 210, or the seller 210 can receive a verbal confirmation of a selection (e.g., by the seller 210 specifically asking the buyer 205, or by the buyer 205 reviewing the list of masked cards and indicating a particular selection).

At 416, the seller 210 can prompt the buyer 205 for entry or provision of a remote redeem code prior to completing the transaction with the selected card. Alternatively, the seller 210 can ask for a verbal confirmation or provision of the redeem code, which can be confirmed or entered by the clerk or merchant.

In parallel with the prompting of 416, the seller 210 can note which card is selected to the cloud service 215. The cloud service 215 can then, at 418, generate a unique and single-use redeem code, which can be transmitted to the buyer 205. The buyer 205 can receive the remote redeem code at 420, and when prompted, provide that code to the seller 210 for verifying the buyer's identity. In some instances, the remote redeem code may be generated automatically when the SMS number is first received by the cloud service (e.g., at or after 408 or 410). This may assist in possible fraud mitigation, by notifying the buyer when an attempt is made. In still other instances, the unique identifier may be generated by a browser or dedicated application associated with the cloud service 215 and executing at a mobile device of the buyer 205. Known algorithms can be used in the generation, such that the cloud service 215 will be able to confirm whether or not the app-generated identifier is valid and associated with the buyer 205 and his or her mobile device.

At 422, the seller 210 can receive and enter or otherwise capture or input the redeem code, and send that code to the cloud service 215 for validation. The redeem code can be entered into the POS by either the seller 210 or the buyer 205. If the redeem code matches what was sent to the buyer 205, then the cloud service 215 can approve or confirm the redemption. If the code does not match, no code is given, or the redeem code entered has expired, the attempt can be rejected. The approval can be provided to the seller 210, where the gift card can be redeemed and the transaction completed at 426. In some instances, the seller 210 can provide the amount of the redemption, either at 406, or after completion or approval, to allow the cloud service 215 to update the amount on the associated gift card.

In some instances, at or in conjunction with 416, the request for remote code is pushed to the cloud service 215, which is then provided to or received at the buyer 205 (e.g., via secure communication via text using SMS application 101 or to a dedicated application or browser 103, as illustrated in example FIG. 1). The buyer 205 can then determine whether the redemption is allowed, and can approve the request to generate the code in any suitable manner through interactions with his or her mobile device. In such instances, operation 418 can be used to trigger the unique code or identifier generation, which then is received at the buyer at 420. At that time, the generated code can either be provided back to the seller at 422 so that seller can enter the value as needed for redemption, or at 420, the buyer 205 may have an option to select an “Auto Reply” button or “Acceptance” element so that the redeem approval request is sent directly to cloud service 215, which, via websocket and web hook, for example, can push the redeem code directly into step the prompt provided by the seller 210 at 422, thereby allowing the redemption to be completed. This may be considered an automatic redemption code reply, which provides buyers 205 with the ability to bypass showing the code to the seller 210.

It is noted that similar concepts can also be applied to credit cards, discount coupons, and other payment card types, as well as cryptocurrency tokens operating in a non-integrated manner, as each may benefit from the secure remote redemption methodology. For example, as long as such payment cards are registered by the user (e.g., in this case user-initiated registration), then future use of such payment cards (e.g. credit cards, discount coupons, other payment cards, cryptocurrency tokens, etc.) can be used in a similar manner to the gift card redemption description of FIG. 4. In those instances, instead of sending back the masked gift cards, cloud service 215 may send back a set of masked payment cards for a store clerk or buyer 205 to select, where, in response, a redeem code is generated and requested for input prior to allowing the payment to occur. Once the transaction and identity is verified and the information is provided to the cloud service 215, the solution can process that request accordingly, such as a credit card authorization, a discount coupon redemption, other payment card authorization, or a cryptocurrency private key signing by cloud service 215 before submitting to blockchain—with each of these transactions occurring without the need to divulge the actual payment data to the recipient parties.

Alternative descriptions of the solution are provided below as examples. For example, at 501, when a buyer acquires the gift card (whether physical or electronic, whether in-store, via phone, via web, via market), the seller 210 prompts for the buyer's SMS enabled mobile number, or other identifier, at 502.

At 503, when the gift card is issued (sold to buyer), the gift card account number and the buyer's SMS mobile number are sent to a cloud-based gift card registry service, where the gift card account number and the SMS number are registered at 504.

At 505, the cloud service generates an SMS message to the buyer notifying them of the issuance, and the buyer 205 receives the SMS text at 506, which includes a confirmation that the gift card was issued, and provides a URL or other location visit the gift card wallet for review and use. Unlike other solutions, the buyer does not have to do anything else to have access to the card's value, such as manual card activation or registration.

After receiving the SMS, the buyer can, at any suitable time, visit the URL indicated on the SMS text in 506. The cloud service 215 associated with the URL can ask for the SMS mobile number of the consumer, and can and verify the SMS number via a SMS code sent back to the buyer 205 to validate and confirm that the buyer is in possession of the corresponding device at 508 and 509. Any suitable type of two-factor authentication, or other verification, can be used. After verification, the gift card wallet URL can be accessed at the buyer's leisure at 510, allowing the buyer 205 to view all gift cards they have acquired from all participating merchants/sellers, as well as those that are seller-agnostic, such as Visa debit gift cards, American Express gift cards, and other options. Again, to add these cards to the buyer's wallet, the buyer did not have to do any manual card addition or registration, as automatic registration was performed via SMS mobile number linking at the point-of-sale.

In some instances, if the buyer wants to send a gift card in the gift card wallet to someone, the buyer can simply enter the SMS mobile number of other person and the same card delivery is achieved (i.e., the receiver simply visits the gift card wallet URL and see the cards appear in their account, after they have registered with the cloud service 215). The sending feature described herein may be used with gift cards, reward points, and discount coupons, among others. In general, credit cards and cryptocurrencies usually may not be sent in this manner. However, the solution described herein could supplement or otherwise be a part of a cryptocurrency wallet, and normal transaction methods could be used therein.

Additionally, if the buyer already knows of their cloud-based gift card wallet, and has already registered their number, then they can simply visit the wallet URL immediately after acquiring the gift card, without waiting for the SMS text notification of 506. That is, the text sent by the cloud service 215 notifying of the new card can be a notification, not a trigger.

In another further solution, if the buyer wants to reload or redeem the gift card securely, whether in-store, via a web-based payment or website, or by phone, the buyer only needs to provide the SMS mobile number to the store clerk or online web system. There is no need to expose the card number at all, such as by entering the particular numbers associated with an existing account. To do the redemption or reloading, the store clerk or online web system enters the SMS mobile number (or other identifier) into the POS or system, and can interact with the cloud service, validate the mobile number, and can provide the list of masked card numbers showing only the last 4 digits of each card. This return data is non-sensitive and cannot be used for redemption. In the case of in-store self-service, or web-based interactions, entering the SMS mobile number (or other unique identifier) will be followed by a redeem code validation to ensure security. The use of SMS or other identifiers alone to redeem values without a confirmatory redeem code can be insecure. However, in other solutions described herein, the use of biometric authentication can be used to avoid the need for provision and entry of a redeem code. In some cases, a corresponding biometric PIN can be used to provide additional support, requiring both biometric validation and a corresponding confirmatory PIN.

If the store clerk (in-store or phone) is going to reload (add funds) to the gift card, the store clerk picks a secured and masked gift card from list and continues to reload and complete the process, without divulging confidential card data. If the store clerk (in-store or phone) is going to redeem a gift card, then the merchant's POS can prompt for a remote redeem code as described.

The remote redeem code can be dynamically generated by the buyer (cardholder's) gift card wallet that is associated with the SMS mobile number. This redeem code is single use and valid for a limited timeframe only. The buyer can provide this remote redeem code to the store clerk to authorize the card redemption. Absence or invalidity of this code will mean no redemption is allowed.

In the case of an online transaction where the buyer is using a self-serve process to reload a card on the merchant's website rather than its own in-app gift card wallet, in order to not expose card number, the same idea is utilized as described above.

For online transactions where the buyer is using a self-service process to redeem a card on the merchant's website rather than its own in-app gift card wallet, in order to not expose card number, similar operations are used as the in-store redemption. Specifically, the buyer himself will select the masked card to redeem after entering SMS mobile number, and the buyer will enter the remote redeem code generated by the gift card wallet to authorize the transaction.

Since this solution is layered on top of existing gift card delivery systems, if the buyer still wishes to use the traditional physical or electronic gift card medium, he still can, although in doing so, they will not be protected from the card security concerns described herein. The described solution provides a number of advantages offering a better experience for consumers, including (1) automatic association of a purchased gift card to a buyer when such transaction is performed outside of an in-app experience, where the buyer is typically unknown to the store/merchant's point of sale system; (2) automatic association of a purchased gift card to a buyer without buyer performing any additional steps in order to add or register such gift card to their online account; and (3) automatic presentation and inclusion of purchased gift cards in buyer's SMS mobile number-based online account without any extra actions by the user. Still further, a physical gift card can be turned into an e-Gift card (electronic) without any further system changes by adding the relevant card number to the mobile wallet. Further redemptions can be performed using the current system after such association. Further, funds can be reloaded and redeemed for a physical, electronic gift card without exposing the gift card number to the public by using the mobile number as a unique account identifier, and using a dynamic redemption code generated by the cardholder for a single-use and time-limited solution to control fraud and fight theft. Still further, existing gift card solutions can co-exist with the described solution, so that physical gift card, electronic gift cards, and the new SMS e-gift cards can work together for maximum flexibility based on the buyer's preference, with the opportunity for significant increases in security.

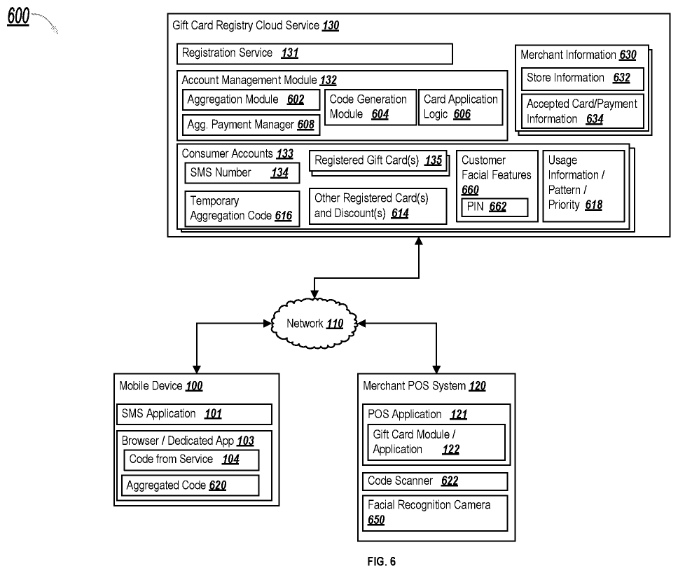

FIG. 6 describes an enhanced version of the system described in FIG. 1, and provides for a solution where a consumer or buyer has multiple gift and/or other payment cards associated with their account. Additionally, the system of FIG. 6 allows for biometric-based payments in other alternative solutions. As described, several components included in FIG. 1 have been illustrated, and are included here as updated or changed with additional or alternative functionality and components. Additionally, further components are included and can be used to provide the additional solutions described herein.

As illustrated, FIG. 6 includes cloud service 130, network 110, one or more mobile devices 100, and a merchant POS system 120. Beginning with the cloud service 130, a registration service 131 similar to that described in FIG. 1 may be present, and can be used to register one or more gift cards, as well as standard payment options, such as credit cards, PIN-less debit cards, or other accounts. When the solution stores credit cards, prepaid PIN-less debit cards, or prepaid credit cards, the cards can be stored as payment tokens issued by the processor or card brand to represent those cards, thereby allowing the solution to ensure security and meet required financial regulations and rules. In some instances, the tokens may be associated with, or otherwise present, a portion of the actual number (e.g., the last 4 digits of the card or account number), or may be provided a nickname or other reference. Any suitable identification scheme to differentiate the cards can be used.

As illustrated, the cloud service 130 includes a registration service 131, which can be similar to or different than the registration service 131 described in FIG. 1. The registration service 131 can be used as previously described to register new gift cards with the cloud service 131. In some instances, included as described herein, the registration service 131 (or another suitable component) can register credit and other payment cards to the particular consumer, and can associate those cards with the consumer's corresponding account 133. In some instances, the wallet application on the mobile device can be used to perform the credit and other payment card registration manually, if desired. For reward points accounts and discount or promotional coupon associations, a similar mechanism as described for gift card registration can be used. That is, merchants can simply push any relevant account numbers into the wallet via SMS number association.

The cloud service 130 includes the account management module 132, which can be used to allow customers/consumers to interact with their own accounts. As previously noted, the module 132 can allow consumers to view balances, add funds, or transfer particular cards (i.e., gift cards, discounts and promotions, and reward points—not credit cards) to other consumers associated with different SMS numbers. As illustrated herein, the account management module 132, or any other suitable component, can perform additional operations in the aggregated card implementation. As shown, the account management module 132 includes an aggregation module 602 that can be used to perform and/or initiate or assist in various operations performed in the aggregated card payment implementation. A code generation module 604 can be used to generate a unique and time-limited value, code, or identifier that can be used by the consumer to represent multiple cards for an aggregated payment option. The code generation module 604 can associate any generated value as a temporary aggregation code 616, which can be stored in or otherwise associated with the particular consumer account 133 of the consumer. The aggregation code 616 can be generated by the account management module 132, in some instances, in response to an indication from the mobile device 100 that an aggregated payment option is desired or requested. In some instances, the temporary codes 616 may be generated at intervals, and can be ready to be provided and used within certain validity periods before the code expires. When a code 616 expires, it can be deleted, and the new code 616 can be stored in its place. In some instances, the codes 616 may be represented by a QR code or other scannable value other than numeric or alphabetic combinations, while in some instances, the code 616 may be an alpha-numeric combination.

The account management module 132 may also include a set of card application logic 606, where the card application logic 606 can be used to determine an order to apply particular cards from a set of available cards, such as the set of registered gift cards 135 and the other registered cards and discount codes 614 (e.g., credit cards, discount codes, and other payment options associated with a particular consumer account 133). In some instances, the logic 606 may be based on predefined rules or logic, and may depend on which cards are available to use for a particular merchant. In some cases, gift cards specific to the current merchant can be applied first, with other generic or general-purpose gift cards (such as Visa or American Express gift cards applicable at any business accepting similar cards) can be applied next. If any balance is left after those types of cards are used, then credit cards and/or other payment sources can be applied to the balance. In some instances, a stored and dynamic set of prior usage information, or usage patterns or priorities 618 can be used with the logic 606 to adjust payment methods for particular consumers. The information 618 can be based on identified preferences of the consumer, as well as on prior transactions or specific preferences defined for the consumer account 133. Each consumer may have a separate set of instructions or preferences defined that can supplement or override the card application logic 606.

The aggregated payment manager 608 can perform the prioritization analysis based on the logic 606, and can then process each payment with the respective source, debiting amounts from the transaction via the stored values associated with the consumer accounts 133, and determining if any additional funds are needed. If so, the payment manager 608 can cause other registered cards 614 to be used, such as by interacting with a credit card payment interface and completing the purchase. The aggregated payment manager 608 can then provide information regarding the two or more completed redemptions and/or transactions performed to the merchant POS system 120, which can then finalized the transaction and provide the consumer associated with the mobile device 100 their receipt and goods/services.

As illustrated, the cloud service 130 can store merchant-specific information 630, which can include information about particular stores 632, as well as information associated with the accepted cards and payment options for a particular merchant and/or store location of the merchant. In some instances, one or more types of payment cards may not be accepted by a merchant. Upon receiving the request from the merchant POS system 120 to transact an aggregated card payment attempt, the merchant information 630 can be used to determine which of the consumer's cards can be applied. Further, different locations of a merchant may accept different types of cards, such as franchises or other subsets of locations. The location-specific information 632 can be used to identify the specific set of payment options for that store before attempting to redeem and apply available funds and payment options.

As illustrated, and for use in a biometric-based payment alternative, some consumer accounts 133 may store consumer facial features 660 or other biometric data, which can be used to verify a consumer's identity and associate a transaction with their consumer account 133. To provide additional protection, those facial or biometric features 660 can be protected by a PIN 662, which may be required entry for additional verification prior to allowing a biometric transaction to occur.

Network 110 in FIG. 6 is similar to network 110 of FIG. 1, and allows the various components illustrated to communicate with one another, and allows information to be shared between devices and systems.

Mobile device 100 may be similar to mobile device 100 of FIG. 1, and can use the SMS application 101 to register their cards and other accounts to the consumer account 133. Cards can also be registered to the consumer account 133 through the processes described herein, without the need for user interaction—only their SMS number 134 may be needed to redeem and/or reload the cards at certain merchants. Using the SMS application 101, or a browser or dedicated application 103, the consumer may be able to initiate the aggregated card payment interaction via their device 100. In response to that indication or initiation, the account management module 132 can provide the unique code to the mobile device 100 in any suitable manner, with the consumer able to provide the aggregated code 620 to the merchant POS system 120 during a redemption process. In some instances, the unique code can be presented on a UI of the mobile device 100 and scanned by the merchant POS system 120. In other instances, the unique code may be securely transmitted, locally or through a network, to the merchant POS system 120 for review.

The merchant POS system 120, which may be similar to the system 120 described in FIG. 1, can further include a code scanner 622. The code scanner 622 may be a camera-enabled device capable of scanning an image of or associated with the aggregated code 620 from the mobile device 100. Once scanned, the POS application 121 can connect to the cloud service 130, provide the captured code scanner 622 and any merchant- and/or store-specific identifiers, thereby allowing the account management module 132 to determine the available payment sources, prioritize those available sources, and redeem the gift cards or process further transactions in completing the aggregated transaction. The POS system 120 can then receive information regarding the completed interactions and partial transactions, and can generate a receipt and record the transaction in their system, as required.

The merchant POS system 120 is also illustrated as having a facial recognition camera 650, which can allow consumers to perform device-less transactions based on their previously-stored biometric information and stored payment options. When arriving at the merchant, the consumer can identify or indicate that a device-less transaction is to be performed. In some instances, the illustrated system may automatically capture the biometric information and make the option to use the device-less system at payment. Consumer preferences may opt-out of such automatic attempts. The facial recognition camera 650, or any other suitable biometric input source, can capture the necessary biometric data and share that data with the cloud service 130. Upon determining the consumer's identity, the transaction can be performed without the need to use the consumer's mobile phone 100 or physical cards. In some instances, the POS system 120 may be required to receive a corresponding PIN code 662 from the consumer prior to completing the transaction. The biometric solution can be used with the aggregated payment solution, and can be used to apply multiple cards or values to a transaction. In some instances, the code scanner 622 and the facial recognition camera 650 may be the same component or device.

In some implementations, facial or other biometric identification methods may be used as a solution for web-based or in-app payment identification. In other words, consumers, when transacting via the web or an in-app interaction outside of the wallet, or using merchant hardware, and if the target web store, in-app functionality, or merchant is integrated to the biometric engine of the cloud service, can use the standard camera (or other sensors) on the mobile device or merchant system to capture and identify the facial (or other biometric) features of the consumer and confirm their identity via the cloud service.

FIG. 7 describes a process 700 for performing an aggregated card transaction managed by the cloud service, and describes operations performed by the buyer 205, the seller 210, and the cloud service 215.

At 702, the buyer 205 can initiate an interaction for an aggregated card payment option. Using techniques described herein, the buyer 205 may have multiple gift and other payment cards registered with the cloud service 215, and available for use. By initiating the aggregated option, the buyer 205 can notify the cloud service 215 and prep for the transaction. In some instances, an application at the mobile device of the buyer 205 can send a notification or request for a unique aggregation code or identifier to be generated to the cloud service 215.

At 704, the cloud service 215 receives the request and generates a unique code or identifier associated with the buyer's account, and allowing an aggregated payment to be used. The unique code or identifier can be any suitable format, and may be a scannable barcode or QR code. The code or identifier may be valid for a temporary period, such as 5-10 minutes, as well as other intervals. At 706, the unique code is transmitted back to the buyer 205, where it is received at 708.

At 710, the buyer 205 can interact with seller 210, and in response to a request for payment, can provide the unique code from the cloud service 215 to the seller 210. In some instances, the seller 210 can scan and obtain the unique code with a camera or code scanner associated with their POS system. At 712, the seller 210 obtains, captures, or receives the unique code with which to complete the transaction. The seller 210 can then provide the unique code, along with transaction information (e.g., an amount of the transaction) and merchant and/or store identifiers, to the cloud service 215 for processing. In some instances, SKU-level information may be provided to the cloud service 215, as certain gift cards and/or discount may be usable only with particular products or manufacturers, and not the entirety of the transaction.

At 716, the cloud service receives the information from the seller's system, and can identify and confirm the consumer associated with the unique code (after verifying the code is still valid). The cloud service 215 can also identify and confirm the merchant and store identifiers associated with the transaction, as well as any transactional-relevant information included in the transmission. At 716, the cloud service 215 may also identify the cards and accounts associated with the identified consumer. In some instances, only gift cards or payment options with available funds and/or active accounts may be identified. Zero balance gift cards may not be included in the further considerations, in some cases.

At 718, a set of available cards and payment options associated with and capable of being accepted by the merchant and/or store associated with the transaction can be determined. As noted, some merchants and stores may be limited in the gift and payment cards that they can use in transaction.

At 720, based on the determined set of payment options associated with the consumer account and the options usable at the merchant, a priority order of payment application can be determined by the cloud service 215. In some instances, a hierarchy of payment options can be defined by a set of payment logic. In some instances, for example, merchant- and/or store-specific gift cards can be given first priority in the application of funds/payment options. Next, non-merchant-specific cards registered to the consumer can be given next priority. Any other payment options can then be provided third priority, in those instances. Within that third priority, however, merchant-specific credit and/or debit cards may be given relatively higher priority for payment.

At 722, the determined priority of application can be used to perform the transaction, and those balances and cards can be applied against the current transaction until the amount needed is provided, or until no funds and/or payment options remain available to the consumer. The cloud service 215 can provide the used payment information to the seller 210, and confirm that all amounts required have been applied, and/or that any additional funds are required.

At 724, the transaction can be completed by the seller 210 based on the completed cloud service transactions. Should any further funds be required, the seller 210 can request those additional funds from the buyer 205 at that time. Once all required amounts are transacted, the transaction can be completed.

As an example of the interactions shown in FIG. 7, a proposed transaction for $100 is considered. After a QR code associated with the consumer has been generated and is provided to the seller 210, the seller 210 provides that code and information about itself, and in some cases, the transaction, to the cloud service 215. In this instance, we assume that the buyer has 3 different gift cards registered, each with a balance of $20 each, with one of the gift cards being a merchant-specific card for the seller 210, and another gift card that is specific to another, different merchant. The buyer 205 here may also have one or more credit cards associated with their account to be used should any additional funds be needed. After identifying the consumer based on their unique code, and after confirming the code is still valid, the cloud service 215 identifies the available sources of funds for the consumer, as well as which of those cards are usable by the seller 210. Here, the other merchant-specific card may not be usable at the merchant, so the cloud service 215 can prioritize the order of payment as the $20 for the merchant-specific card, then the $20 for the other non-merchant-specific card. Once the $40 dollars is applied to the $100 balance, only $60 remains. Based on the consumer having a registered credit card with their account, the cloud service 215 can apply the rest of the balance to that credit card. Once the transactions are completed, the cloud service 215 can notify the seller 210 (and optionally, the buyer 205 as well with the updated balances). The seller 210 can then finalize and complete the transaction.

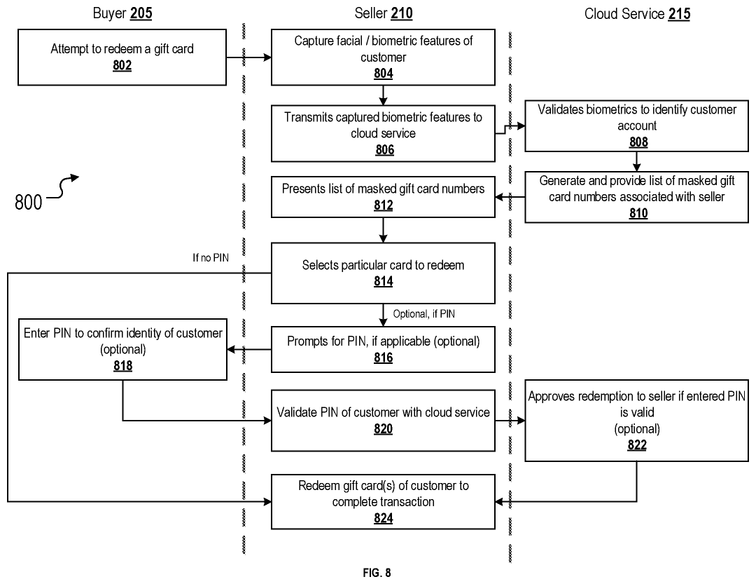

FIG. 8 describes a process 800 for performing a biometric redemption process managed by the cloud service, and describes operations performed by the buyer 205, the seller 210, and the cloud service 215.

At 802, a buyer 205 can attempt to redeem a gift card or other payment method via a biometric payment option. In such cases, the illustrated system may be set up to avoid requiring the buyer 205 from using their mobile device and/or an associated SMS number to initiate a card redemption, such that only their physical features will be used to initiate the transaction. Further, in some instances, attempting to redeem a gift card or other payment option may include indicating to the seller 210 that a biometric redemption is to be used. In others, the biometric option may automatically be initiated when the consumer is near a designated check-out area or location, and makes themselves available to a biometric sensor or other input.

At 804, the seller 210, using any suitable sensor or input system, can capture biometric features of the consumer for use with the cloud service 215. In some instances, facial recognition feature can be captured, such as through a facial scanner. The facial scanner may be associated with a mobile device or camera of the seller 210, and can take the customer's picture or capture their image for use in correlating the customer to an existing consumer account. In other instances, a fingerprint, retinal, or other biometric input scanner or device can capture relevant biometric information. Any suitable method of extracting and comparing biometric features can be used in various implementations. For example, for facial recognition, a deep learning methodology can be used to extract facial features of the consumer, and those features can be stored. When an attempted biometric interaction is performed, the facial scanner can extract facial features of the consumer at the merchant, and the cloud service can compare those to the stored facial features of the plurality of consumers to identify a match. At 806, the seller 210 can transmit the captured biometric information to the cloud service 215.

At 808, the cloud service 215 receives the captured biometric information and compares or validates that information to a particular customer. To do so, customers may have previously registered with the cloud service 215 to provide a sample or baseline set of biometric data that can be used in the validation. By comparing key points of the biometric data received from the seller 210 to the pre-existing biometric samples, the cloud service 215 can identify a corresponding customer associated with the transaction.

Upon identifying the customer, at 810 the cloud service 215 can generate and provide a list of masked gift card and/or payment options of the identified customer and available for use at the seller 210. In some instances, existing rules and/or preferences can be applied to choose a particular payment option as a preferred payment option. If an aggregated payment card method is being used in combination with the biometric payment, then a list does not need to be generated, and the card selection operation can be skipped entirely, if desired.

The list of masked gift or payment and payment card numbers can be provided at a UI associated with the seller 210, allowing the buyer 205 and/or the seller 210 to select a particular card for redemption. At 814, a particular card is selected. If no PIN is associated with the biometric data, method 800 continues at 824. If a PIN is used to protect the biometric data, then after the selection of the card, or, alternatively, prior to providing the set of masked gift and payment card options, the seller 210 can prompt the buyer 205 to enter the associated PIN. The buyer 205, at 818, can then provide the PIN to confirm their identity. At 820, the seller 210 can receive the PIN and submit to the cloud service 215, where the cloud service 215 determines whether the PIN is correct at 822. If the PIN is incorrect, the biometric payment is rejection. If the PIN is valid, then the seller 210 is notified, and the selected card or cards are used/redeemed to complete the transaction at 824.

In some instances, the biometric redemption process can be used to allow an aggregated card payment process. In those instances, customers may be able to authorize, prior to the transaction, the use of an aggregated set of cards. If a single card option cannot complete the transaction, and based on the validation of the buyer 205 and their predefined approval, the cloud service 215 can identify and prioritize available payment options, and perform the transactions associated with those options to complete the transaction.

Certain novel aspects of the subject matter of this specification are set forth in the description and claim provided in this document.

Embodiments of the subject matter and the operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification, the different functions can be implemented using “engines,” which broadly refer to software-based systems, subsystems, or processes that are programmed to perform one or more specific functions. Generally, an engine is implemented as one or more software modules or components, installed on one or more computers, in one or more locations. In some cases, one or more computers can be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing models described in this specification can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claim in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer implemented method, comprising:
receiving, at a cloud service, a notification from a merchant associated with a new payment card activation, the notification including a unique messaging identifier corresponding to a consumer account associated with the new payment card and a value of the new payment card;
associating, by the cloud service and in a consumer account associated with the unique messaging identifier, the new payment card and the unique messaging identifier;
assigning, by the cloud service, the new payment card a value associated with the value of the new payment card;
generating, by the cloud service, a notification message specific to the consumer account associated with the unique messaging identifier and the new payment card; and
transmitting, by the cloud service, the generated notification to the unique messaging identifier of the consumer account.

2. The method of claim 1, wherein the unique messaging identifier comprises a phone number of the consumer or a short messaging service (SMS) number associated with the consumer.

3. The method of claim 1, wherein the new payment card comprises a gift card.

4. The method of claim 3, wherein the gift card is a gift card for the merchant associated with the new payment card activation.

5. The method of claim 3, wherein the gift card is a gift card purchased at the merchant associated with the new payment card activation, wherein the gift card is not specific to the merchant.

6. The method of claim 1, wherein the notification message includes a uniform resource locator (URL) providing a link to a consumer-specific account wallet associated with the cloud service.

7. The method of claim 1, wherein the merchant is a first merchant and the unique messaging identifier is a first unique messaging identifier, the method further comprising:
receiving, from a second merchant, a second unique messaging identifier associated with an attempt to redeem value from a consumer account, the second unique messaging identifier provided by the second merchant;
validating, by the cloud service, the received second unique messaging identifier to determine an associated consumer account;
generating, by the cloud service, a list of one or more payment cards associated with the determined consumer account, wherein the list of one or more payment cards is masked such that only a portion of an identifier or account number of each payment card is visible;
transmitting, by the cloud service, the generated list of one or more payment cards to the merchant;
receiving, from the second merchant, an identification of a particular payment card from the generated list to be used for the attempted redemption; and
processing, by the cloud service, the attempted redemption from the consumer account using the particular identified payment card.

8. The method of claim 7, further comprising, after receiving the identification of the particular payment card and prior to processing the attempted redemption:
generating, by the cloud service, a third unique identifier representing a redeem code;
transmitting, by the cloud service, the third unique identifier to a device associated with the second unique messaging identifier, wherein the third unique identifier is used to verify the consumer associated with the second unique messaging identifier;
receiving, from the second merchant, a fourth unique identifier, wherein the fourth unique identifier is received by the second merchant from a user attempting the redemption;
comparing, by the cloud service, the received fourth unique identifier to the generated third unique identifier;
in response to determining that the received fourth unique identifier is the same as the generated third unique identifier, authorizing the processing of the attempted redemption.

9. The method of claim 8, wherein the generated third unique identifier is associated with a validity period, and wherein if the generated third unique identifier is not received from the second merchant within the validity period, then the processing of the attempted redemption is not authorized.

10. A non-transitory computer-readable medium to store instructions, which when executed by a computer, cause the computer to perform operations comprising:
receiving a notification from a merchant associated with a new payment card activation, the notification including a unique messaging identifier corresponding to a consumer account associated with the new payment card and a value of the new payment card;
associating, in a consumer account associated with the unique messaging identifier, the new payment card and the unique messaging identifier;
assigning the new payment card a value associated with the value of the new payment card;
generating a notification message specific to the consumer account associated with the unique messaging identifier and the new payment card; and
transmitting the generated notification to the unique messaging identifier of the consumer account.

11. The non-transitory computer readable medium of claim 10, wherein the unique messaging identifier comprises a phone number of the consumer or a short messaging service (SMS) number associated with the consumer.

12. The non-transitory computer readable medium of claim 10, wherein the new payment card comprises a gift card.

13. The non-transitory computer readable medium of claim 12, wherein the gift card is a gift card for the merchant associated with the new payment card activation.

14. The non-transitory computer readable medium of claim 12, wherein the gift card is a gift card purchased at the merchant associated with the new payment card activation, wherein the gift card is not specific to the merchant.

15. The non-transitory computer readable medium of claim 10, wherein the notification message includes a uniform resource locator (URL) providing a link to a consumer-specific account wallet.

16. The non-transitory computer readable medium of claim 10, wherein the merchant is a first merchant and the unique messaging identifier is a first unique messaging identifier, the operations further comprising:
receiving, from a second merchant, a second unique messaging identifier associated with an attempt to redeem value from a consumer account, the second unique messaging identifier provided by the second merchant;
validating the received second unique messaging identifier to determine an associated consumer account;
generating a list of one or more payment cards associated with the determined consumer account, wherein the list of one or more payment cards is masked such that only a portion of an identifier or account number of each payment card is visible;
transmitting the generated list of one or more payment cards to the merchant;
receiving an identification of a particular payment card from the generated list to be used for the attempted redemption; and
processing the attempted redemption from the consumer account using the particular identified payment card.

17. The non-transitory computer readable medium of claim 16, the operations further comprising, after receiving the identification of the particular payment card and prior to processing the attempted redemption:
generating a third unique identifier representing a redeem code;
transmitting the third unique identifier to a device associated with the second unique messaging identifier, wherein the third unique identifier is used to verify the consumer associated with the second unique messaging identifier;
receiving a fourth unique identifier, wherein the fourth unique identifier is received by the second merchant from a user attempting the redemption;
comparing the received fourth unique identifier to the generated third unique identifier;
in response to determining that the received fourth unique identifier is the same as the generated third unique identifier, authorizing the processing of the attempted redemption.

18. The non-transitory computer readable medium of claim 17, wherein the generated third unique identifier is associated with a validity period, and wherein if the generated third unique identifier is not received from the second merchant within the validity period, then the processing of the attempted redemption is not authorized.

19. A computer system, comprising:
at least one processor; and
one or more memories coupled to the at least one processor and storing programming instructions for execution by the at least one processor to:
receive a notification from a merchant associated with a new payment card activation, the notification including a unique messaging identifier corresponding to a consumer account associated with the new payment card and a value of the new payment card;
associate, in a consumer account associated with the unique messaging identifier, the new payment card and the unique messaging identifier;
assign the new payment card a value associated with the value of the new payment card;
generate a notification message specific to the consumer account associated with the unique messaging identifier and the new payment card; and
transmit the generated notification to the unique messaging identifier of the consumer account.

20. The system of claim 19, wherein the merchant is a first merchant and the unique messaging identifier is a first unique messaging identifier, wherein the programming instructions for execution by the at least one processor to:
receive, from a second merchant, a second unique messaging identifier associated with an attempt to redeem value from a consumer account, the second unique messaging identifier provided by the second merchant;
validate the received second unique messaging identifier to determine an associated consumer account;
generate a list of one or more payment cards associated with the determined consumer account, wherein the list of one or more payment cards is masked such that only a portion of an identifier or account number of each payment card is visible;
transmit the generated list of one or more payment cards to the merchant;
receive an identification of a particular payment card from the generated list to be used for the attempted redemption; and
process the attempted redemption from the consumer account using the particular identified payment card.
